(19) United States
(12) Patent Application Publication
(10) Pub. No.: US 2011/0297889 A1
(43) Pub. Date: Dec. 8, 2011

(54) METHOD FOR MANUFACTURING A COMPOSITE MATERIAL OF SnO2 AND CARBON NANOTUBES AND/OR CARBON NANOFIBERS, MATERIAL OBTAINED BY THE METHOD, AND LITHIUM BATTERY ELECTRODE COMPRISING SAID MATERIAL

(75) Inventors: Dominique Plee, Lons (FR); Mohamed Chakir, Vif (FR); Patrice Simon, Toulouse (FR)

(73) Assignees: UNIVERSITE PAUL SABATIER ( TOULOUSE III ), Toulouse (FR); ARKEMA FRANCE, Colombes (FR)

(21) Appl. No.: 13/133,835

(22) PCT Filed: Dec. 4, 2009
(86) PCT No.: PCT/FR09/52408

§ 371 Date: Aug. 24, 2011

(30) Foreign Application Priority Data
Dec. 11, 2008 (FR) 0858459

(51) Int. Cl. H01B 1/24; H01B 1/04; H01B 1/02; B82Y 99/00; B82B 3/00

(52) U.S. Cl. 252/506; 252/520.1; 977/842; 977/742

(57) ABSTRACT

A method for manufacturing a composite material including tin oxide particles and a fibrillar carbon material, including synthesising tin hydroxide particles obtained from a tin salt by precipitation/nucleation in a water-alcohol medium, in the presence of the fibrillar carbon material and an acid, the fibrillar carbon material being nanotubes, carbon nanofibres, or a mixture of the two. The method can be used for the production of negative electrodes for lithium-ion batteries.

### TECHNICAL FIELD OF THE INVENTION

The invention relates to a process for manufacturing a composite comprising a fibrillar carbon-based material and tin oxide. The expression “fibrillar carbon-based material” is understood to mean carbon nanotubes CNTs or carbon nanofibers CNFs or a mixture of the two. The invention also relates to electrodes consisting of said composite and to lithium batteries comprising such electrodes.

The invention applies to the field of the storage of electrical energy in batteries and more particularly in secondary lithium batteries of Li-ion type.

Tin, like silicon, is capable of forming alloys with lithium and of making it possible to obtain capacities that are substantially greater than those that are achieved with graphite.

It is known that the main difficulty in developing these materials lies in the high volume expansion during lithiation, which gives rise to losses of cohesion of the electrodes and losses of electrical contact resulting in a significant reduction in performance.

### PRIOR ART

The increase in portable electronic products has contributed to the growing expansion of the market for batteries, and more particularly for lithium-ion batteries.

Indeed, from several hundreds of thousands in 1995, the worldwide production of lithium-ion batteries reached 500 million in 2000 (compared with 1300 million Ni-MH batteries) then 1700 million in 2005. In 2006, Japan, the leading worldwide producer, itself produced more than 1200 million lithium-ion batteries per annum (ITE Express News, (2005)).

Since the emergence of lithium and lithium-ion batteries, several generations of positive and negative electrodes have successively appeared. In the case of negative electrodes, the most widely used material is carbon graphite due to a long service life owing to the formation of a protective layer during the first cycles of cycling. The reversible capacity of such an anode is 372 mAh/g.

To improve this value, several studies are currently being carried out on various materials such as carbon having a high aspect ratio (e.g. carbon nanotubes) or else metals that can form alloys with lithium (silicon, antimony, tin, etc.).

Some metal oxides may also be used as negative electrode for Li-ion batteries (SiO₂, SnO, SnO₂, etc.). These materials have a capacity considerably greater than that of carbon graphite, but their service life is very limited due to the change in volume in the course of cycling during the alloying reaction. To overcome this problem, several ideas have been put forward, such as the use of particles of nanoscale size or else the development of carbon/tin or carbon/tin oxide composites.

In this regard, J. Xie et al., published an article entitled: “Synthesis and Characterization of High surface area tin oxide/functionalized carbon nanotubes composites as anode materials”, in Materials Chemistry and Physics, 91, (2005), 274-280. This article presents a synthesis pathway in which tin tetrachloride in the presence of carbon nanotubes that are previously surface-oxidized with permanganate, is reduced in the aqueous phase using urea. The suspension containing the nanotubes is stirred ultrasonically. The urea is then added. Several heat treatments follow one another, the last of which consists in placing the material in a furnace at 600° C. The resulting composites show the presence of small particles deposited on the nanotubes, having a size between 10 and 20 nm. A large number of these particles is not on the surface of the nanotubes, but is in the form of aggregates and is consequently not very effective. Furthermore, the use as a negative electrode material is only suggested with no experimental proof making it possible to attest to the results produced in terms of cycling performance and capacity.

Another article by L. Yuan et al., entitled “Nano-structured SnO₂-carbon composite obtained by in-situ spray pyrolysis method as anodes in lithium batteries”, J. of Power Sources, 146, (2005), 180-184, describes the preparation of SnO₂ nanoparticles of 5-15 nm, distributed in a carbon-based matrix synthesized by pyrolysis of a spray-dried solution of sucrose of SnCl₂.

Contrary to the preceding example, electrochemistry experiments were carried out. The initial discharge capacity is 600 mAh/g, which shows that there is a high irreversibility at the start.

However, the plot of discharge capacity as a function of the number of cycles shows a decrease that is even less pronounced when the carbon/carbon+SnO₂ ratio is high. Correlatively, this also means that the electrode has an overall lower capacity.

This solution is not suitable since it does not make it possible to combine both a good cycling performance and a high capacity.

Other publications in which SnO₂ and CNT are combined have been described:
The publication by Zhanhong Yang et al., entitled “Lithium insertion into the composites of acid-oxidized carbon nanotubes and tin oxide” Materials Letters 61 (2007) 3103-3105, describes a mixture of 20% by weight of SnO₂ and 80% by weight of carbon nanotubes, which is used for preparing electrodes. The SnO₂ used in this study was prepared at high temperature (1000° C.). The capacity obtained for this material does not exceed 130 mAh/g.
The publication by J. -H. Ahn, et al., entitled “Structural modification of carbon nanotubes by various ball milling”, Journal of Alloys and Compounds 434-435 (2007) 428-432 describes the preparation of CNT/SnO₂ composites. The synthesis method used consists in treating, at high temperature (600° C.) the CNT/SnO₂ mixtures obtained by impregnation of two types of CNTs (open-end CNTs and closed-end CNTs) in an acid solution of tin (SnCl₂+HCl). The discharge capacity, obtained for the composite based on open-end CNTs is less than 600 mAh/g.

The publication by Zhenhai Wen, et al., entitled “In Situ Growth of Mesoporous SnO₂ on Multiwalled Carbon Nanotubes: A Novel Composite with Porous-Tube Structure as Anode for Lithium Batteries” Adv. Funct. Mater. 2007, 17, 2772-2778, describes a method for the in situ preparation of CNT/SnO₂ composites via a hydrothermal route. The capacity obtained is 350 mAh/g, for 50 cycles.

The publication by Guimin An et al., entitled “SnO₂/carbon nanotube nanocomposites synthesized in supercritical fluids: highly efficient materials for use as a chemical sensor and as the anode of a Lithium-ion Battery”, Nanotechnology 18 (2007) 435707, describes composites prepared via a hydrothermal route. These materials comprise, by weight, 40% of SnO₂ and 60% of CNTs. The capacity obtained after 30 cycles does not exceed 400 mAh/g.

It is understood that in all these publications, the authors always express the capacity relative to the tin contained in the composite, however, it is the capacity of the electrode which matters in the battery application.

Thus, the current prior art makes it possible to observe that most of the studies do not correspond to the technical problem of developing a process for manufacturing a composite based on SnO₂ and on CNTs and more generally on a composite based on SnO₂ and on a simple fibrillar carbon-based material, resulting in a composite that has good electrochemical properties.

Indeed, besides the complexity of the processes described, it emerges that for the SnO₂/CNT composites proposed, the cycling improves when the proportion of active compound, in this case tin oxide, decreases in the composite, this being accompanied by a reduction in the absolute capacity of the composite.

Reference can also be made to the prior art consisting of documents D1, D2 and D3 below:
Document D1 is a publication by WEI, R. et al., entitled “Preparation of carbon fiber/SnO₂”, August 2008, page L2, Experimental section. This document describes a process for covering carbon fibers CFs with tin oxide. The carbon fibers are covered with a layer of SnO₂ and are intended for producing microelectrodes. The process consists in carrying out a cleaning of the carbon fibers with acetone then a treatment with the acid HNO₃ in order to obtain COOH or OH bonds at the surface. The process described consists in dissolving SnO₂ in a mixture comprising 40 ml of ethanol per 60 ml of water, into which 0.22 ml of HCl is added, then in carrying out vigorous stirring at 40° C. The solution continues to be stirred and the cleaned CFs are introduced into the mixture. The stirring of the mixture is continued and other steps of stirring, of adding ammonia, of washing with distilled water then with ethanol and also a drying operation are put together.

Thus, document D1 relates to a process for depositing particles of tin oxide on carbon fibers. It does not describe a process for depositing tin oxide on carbon nanofibers, or on carbon nanotubes. The carbon fibers have a diameter around 10 micrometers. The layer of SnO₂ deposited on the surface of a fiber, according to this document, preferably has a thickness of 250 nm.

According to embodiments of the present invention, the carbon-based material consists of CNTs or of CNFs or of a mixture of CNTs and CNFs. The diameters of the CNTs and of the CNFs are not comparable to those of the fibers described in D1 since it is a question of nanometers and not of micrometers. Indeed, for example, at most a diameter of 2.2-2.3 nm is achieved for the singular walled CNTs. The multi-walled CNTs have, for example, an external diameter ranging from 3 to 50 nm and the CNFs have, for example, diameters of 50 to 200 nm.

Furthermore, according to embodiments of the present invention, use is preferably made of multi-walled CNTs having an external diameter ranging from 3 to 50 nm, preferably from 5 to 30 nm and better still from 8 to 20 nm. Indeed, the applicant has observed that the use of multi-walled CNTs makes it possible to obtain a conductivity that is higher, more homogeneous and more stable.
Moreover, the process described in D1 comprises a dissolving operation carried out with stirring at a temperature of 40° C. and not at ambient temperature as in embodiments of the present invention. The pressure under which this step is carried out is not given.
Furthermore, the process described in D1 is complex due to the stirring durations and the additions of components in particular of ammonia.
This process comprises a precipitation with aqueous ammonia, which corresponds to a chemical precipitation/nucleation.

On the contrary, in embodiments of the present invention, the process comprises a nucleation/crystallization phase, which is a physical step since it corresponds to a step of drying then of heat treatment. The drying step leads to an evaporation of the reaction medium (namely water) and therefore physical precipitation. One of the advantages of this physical nucleation step is its ease of industrial implementation (use of a simple evaporator or furnace) and its lack of production of liquid effluent (except the water of the reaction medium); which industrially is advantageous since this leads to less retreatment of the effluents.

Furthermore, the problem that it has been sought to solve in document D1 (WEI et al.), is not the same as that of embodiments of the present invention. Indeed, the problem in D1 is that of obtaining a material having good optical and thermal performances.

In embodiments of the present invention, an exemplary problem solved is the production of a composite comprising a fibrillar carbon-based material (CNT and/or CNF) and tin oxide having a good electronic conductivity, a moderate volume expansion during electrochemical cycling and also a good reversible capacity. In particular, an embodiment of the composite has, in the galvanostatic cycling, a capacity of greater than 600 mAh/g after 60 cycles enabling the production of electrodes.

Document D2 is a publication from 2 Jun. 2008 by Yu-Jin CHEN et al., entitled “High capacity and excellent cycling stability of single-walled carbon nanotubes/SnO₂ core-shell structures as Li-insertion material”. The composite described in this document consists of single-walled nanotubes (SWNTs) and of SnO₂. Document D2 specifies that the initial discharge capacity of the “core-shell” structures is greater than 1399 mAh/g and that the reversible capacities of these structures are stabilized at around 900 mAh/g after 100 cycles. The document also specifies that the diameter of the tin particles deposited at the surface of the nanotubes is around 2 nm and that the length of the single-walled carbon nanotubes (SWNTs) is around 20 micrometers. Thus, the SWNTs/SnO₂ structures have a very large surface area and a very large length/diameter ratio resulting in their high capacity. Indeed, in this case, the reversible capacity of the core/shell structures of nanotubes covered with tin oxide is high.

In D2 (Yu-Jin Chen), the SnO₂ content is not taught; it is not therefore possible to compare the charge/discharge results given with those of embodiments of the present disclosure.

According to embodiments of the present invention, the results are given relative to the SnO₂/CNT composite which contains around 71% by weight of SnO₂.
Document D2 does not explicitly describe the deposition process but indicates that the process used is that described in the publication corresponding to document D3. The process described in document D3 is different from the process of embodiments of the invention as is described subsequently.
Document D3 is a publication from March 2003 by Wei-Qiang Han et al., entitled “Coating single-walled carbon nanotubes with tin oxide”. This document describes a process for depositing tin oxide on single-walled carbon nanotubes. The process described consists in cleaning the surfaces of the carbon nanotubes in a 40% acid bath and under a temperature of 120° C. for 1 h.

The nanotubes are then rinsed with distilled water. 1 g of tin chloride is put into a container containing 40 ml of distilled water, then 0.7 ml of 38% hydrochloric acid is added. 10 mg of previously cleaned single-walled carbon nanotubes are put into the prepared solution. Ultrasonic waves are applied to the solution for 3 to 5 minutes, then it is mixed for 30 to 60 minutes at ambient temperature.

The nanotubes thus treated, are rinsed with distilled water. Then these carbon nanotubes covered with tin oxide are filtered.
The process described in this document D3 is different from the process of embodiments of the present invention since there is no nucleation/crystallization phase carried out at a temperature above ambient temperature nor a heat treatment phase. No alcohol is used either.
Moreover, the process described in D3 comprises a step of filtration of the nanotubes covered with tin oxide. The filtration is an operation which leads to a loss of tin, the process described in this document therefore has a tin yield worse than that of embodiments of the present invention.

The applicant has reproduced the experimental conditions described in this document. The plot of discharge capacity as a function of the number of cycles, obtained under these conditions, is illustrated in FIG. 4 and shows that at the end of the second cycle the capacity falls to 790 mAh/g and that at the end of 12 cycles this capacity falls to 620 mAh/g. With the process of embodiments of the present invention, as can be seen in FIG. 1, the capacity is above 800 mAh/g after 12 cycles. And the poor tin yield was confirmed, this yield being 1.1%, the process used employing a large amount of tin.

The prior art which has just been described moreover consists of theoretical articles with no industrial vision and in particular with no vision of an industrial implementation process.

### DESCRIPTION OF THE INVENTION

An exemplary problem that the applicant has sought to solve by embodiments of the present invention is to propose a process for manufacturing a composite comprising a carbon-based fibrillar material and tin oxide without the drawbacks of the deposition processes that have just been described.

The fibrillar carbon/tin oxide composites thus produced according to embodiments of the present invention exhibit good electronic conductivity, moderate volume expansion during electrochemical cycling and also good reversible capacity.

The applicant proposes a process that makes it possible to control the effects of volume expansion during cycling in order not to give rise to excessively high losses in performance.

Furthermore, the process proposed is simple to implement since it requires temperature conditions that are not very high and atmospheric pressure conditions in order to anchor the particles of tin oxide on the surfaces of the carbon-based fibrillar material. This process is more effective than the solutions known to date since the composite obtained has a charge capacity and discharge capacity after several cycles greater than that of composites made of carbon nanotubes and tin oxide from the prior art.

Moreover, the process does not require any technique liable to impair the performances of the fibrillar carbon-based material used, as is the case in the techniques that use ultrasonic waves. The process makes it possible to use a fibrillar carbon-based material such as carbon nanotubes but also carbon fibers or a mixture of carbon nanotubes and carbon nanofibers.

One subject of the present invention is more particularly a process for manufacturing a composite comprising particles of tin oxide and a fibrillar carbon-based material, mainly characterized in that it comprises a synthesis by precipitation/nucleation in a water-alcohol medium of particles of tin hydroxide resulting from a tin salt in the presence of the fibrillar carbon-based material and an acid, in that the fibrillar carbon-based material consists of carbon nanotubes or carbon nanofibers or a mixture of carbon nanotubes and carbon nanofibers and in that the synthesis comprises a dissolving/contacting phase carried out at ambient temperature and at atmospheric pressure, then a nucleation/crystallization phase carried out at a temperature above ambient temperature and finally a heat treatment phase.

In the dissolving/contacting phase, a) the tin salt is dissolved in a water, alcohol and acid mixture and stirred, water is added while maintaining the stirring, b) the fibrillar carbon-based material is added and the mixture is stirred; it being possible for steps a) and b) to be carried out in this order or in the reverse order.

The nucleation/crystallization phase comprises an evaporation to dryness. Specifically, the drying consists in bringing the reaction mixture to a temperature above ambient temperature (typically 25° C. under 1 atm) but below the boiling point of the mixture (typically below 100° C.)

This evaporation to dryness is, for example, carried out at a temperature between 25 and 80° C. or better still from 40° C. to 70° C.

The heat treatment phase consists of heating the product obtained at a temperature much higher than the boiling point of the reaction mixture. This heat treatment phase is carried out in a furnace, under nitrogen or in air, for about ten minutes, at a temperature between 300° C. and 500° C.

The drying ensures the nucleation, whereas the heat treatment instead ensures the crystallization.

The nucleation is carried out according to an embodiment of the invention via a physical step.

The fibrillar carbon-based material can be added during the dissolving/contacting phase in the form of powder or as a prior predispersion.

The prior predispersion may be carried out by milling in water of planetary ball milling type or equivalent.

In the case where the fibrillar carbon-based material is added in the form of powder, the stirring is a vigorous stirring, which may be identical to that which is carried out in the case of a predispersion. This vigorous stirring makes it possible to break up the aggregates and to increase the density of the material.

In the other cases of stirring, the stirring may be carried out by means of a blade (non-vigorous stirring).

According to another feature of an embodiment of the invention, the fibrillar carbon-based material consists of carbon nanotubes or carbon nanofibers or a mixture of carbon nanotubes and carbon nanofibers.

The expression “carbon nanotubes” is understood to mean hollow tubes having one or more concentric graphite plane walls with an external diameter of 2 to 50 nm. The expression “carbon nanofibers” is understood to mean solid fibers of graphitic carbon having a diameter of 50 to 200 nm, but which may often have a thin hollow central channel. For both nanotubes and nanofibers, the length/diameter ratio is much greater than 1, typically greater than 100.

The applicant has observed that it is preferable, in order to obtain the best results, to treat the fibrillar carbon-based material after manufacture (synthesis). This material is treated so as to remove the catalytic residues present. Thus, the tin oxide particles adhere better to the surfaces. This purification treatment consists in carrying out an oxidation that enables the fibrillar carbon-based material to exhibit polar surface functional groups of OH and/or COOH type.

The purification is obtained, for example, by means of a strong mineral acid such as HNO₃ or H₂SO₄.

The acid treatment is followed by a surface oxidation operation using sodium hypochlorite (NaOCl) or aqueous hydrogen peroxide solution (H₂O₂) or ozone (O₃) when the acid chosen for purifying is not sufficiently oxidizing (for example H₂SO₄).

Embodiments of the invention also relate to the composite obtained by the process as described, the composite mainly being characterized in that it consists of a homogeneous distribution of tin particles over the surfaces of the fibrillar carbon-based material with a virtual absence of tin particles that are not supported by said material.

The composite consists of 20 to 35% by weight of fibrillar carbon-based material and from 65 to 80% by weight of tin oxide particles.

In the case where the fibrillar carbon-based material is a mixture of carbon nanotubes and carbon nanofibers, this mixture consists, preferably at a concentration of 50% by weight, of each of the two constituents.

In the case where the composite described consists of carbon nanotubes and of particles of tin oxide, it has, in galvanostatic cycling, a capacity of greater than 600 mAh/g after 60 cycles.

In the case where the composite consists of carbon nanotubes, carbon nanofibers and of tin oxide particles, it has, in galvanostatic cycling, a capacity of greater than 750 mAh/g after 60 cycles.

The carbon nanotubes are preferably multi-walled CNTs.

Use is preferably made of multi-walled CNTs having an external diameter ranging from 3 to 50 nm, preferably from 5 to 30 nm and better still from 8 to 20 nm since multi-walled CNTs make it possible to obtain a conductivity that is higher, more homogeneous and more stable.

Embodiments of the invention apply to the production of electrodes, comprising a composite as described previously and very particularly to the production of lithium-ion battery negative electrodes.

In particular, an electrode comprises a composite consisting of a mixture of at least 80% by weight of active material (CNT-SnO₂) and at most 20% by weight of binder.

The binder may consist of any liquid, or molecular or polymeric paste, which is chemically inert, generally used to make particles of powder adhere to one another, such as for example polyvinylidene difluoride (PVDF), polyvinylpyrrolidone (PVP) or CMC (carboxymethyl cellulose).

Embodiments of the invention apply to the production of lithium-ion batteries having a negative electrode comprising a composite as described previously.

### BRIEF DESCRIPTION OF THE DRAWINGS

Other features and advantages of the invention will become clearly apparent on reading the following description given by way of non-limiting illustrative example and in conjunction with the figures in which:

FIG. 1 represents the charge capacity and discharge capacity plots of a composite consisting of CNT/SnO₂ as a function of the number of cycles;

FIG. 2 represents a scanning electron microscope photograph of the composite according to an embodiment of the invention with a magnification of 150 000;

FIG. 3 represents a diagram of an exploded view of an individual cell of a lithium battery according to an embodiment of the invention;

FIG. 4 represents the discharge capacity plot as a function of the number of cycles that is obtained under the experimental conditions reproduced by the applicant from document D3 of the prior art.

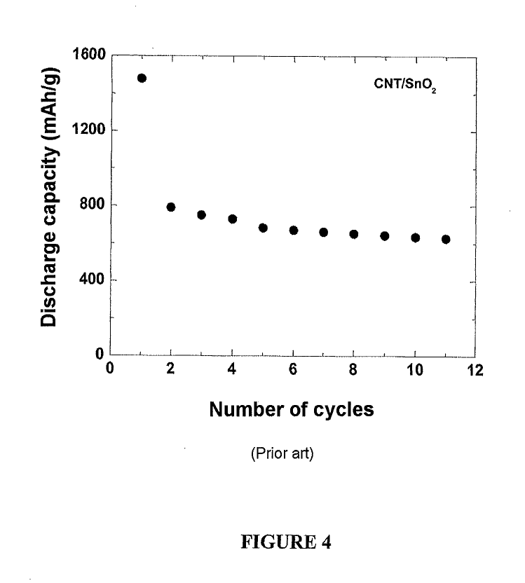

### DETAILED EXAMPLES AND CHARACTERIZATION OF THE RESULTS

The following examples will make the scope of embodiments of the invention better understood.

### EXAMPLE 1

Specific example of implementation of the process for manufacturing the composite. In this example, use is made, as fibrillar carbon-based material, of CNTs that are purified in order to obtain a better attachment of the tin particles as described previously.

The applicant has observed that the carbon nanotubes after synthesis are not suitable for the process. In order for the particles of tin oxide to adhere, it is necessary that the surface of the nanotubes exhibits polar surface functional groups of OH and/or COOH type. These functional groups are obtained by treatment of the nanotubes in a strong acid such as HNO₃ (oxidizing acid) or H₂SO₄ (not very oxidizing acid), which treatment is followed by a surface oxidation operation using sodium hypochlorite if the acid used for the purification is not sufficiently oxidizing.

Other oxidizers, such as H₂O₂ or O₃ may also be used without compromising the scope of the invention.

This observation is also true when it is desired to incorporate carbon nanofibers into the composition.

Moreover, the applicant has observed that tin oxide particles of the order of a few nanometers gave better results. The particles used are advantageously tin oxide nanoparticles.

In this first example, the following steps are carried out:
dissolving 3.8 g of SnCl₂.2H₂O in a mixture of C₂H₅OH. (15 ml)+HCl (37%, 0.1 ml);
stirring for a few hours (1 to 3 hours suffice) using a blade or a magnetic stirrer bar;
adding 90 ml of distilled water and maintaining the stirring for a few hours (1 to 2 hours);
adding 1 g of carbon nanotubes previously purified using H₂SO₄ and surface-oxidized using NaClO, then vigorous stirring if the nanotubes are in the form of powder and not already predispersed, for 2 hours;
evaporation to dryness (in an oven, for example at 60° C.);
heat treatment at 400° C. for 15 min under nitrogen or in air.

It is clear that the reverse order may be followed: a predispersion of nanotubes is firstly prepared, by vigorous stirring, to which nanofibers are optionally added, then the solution of tin salt is added.

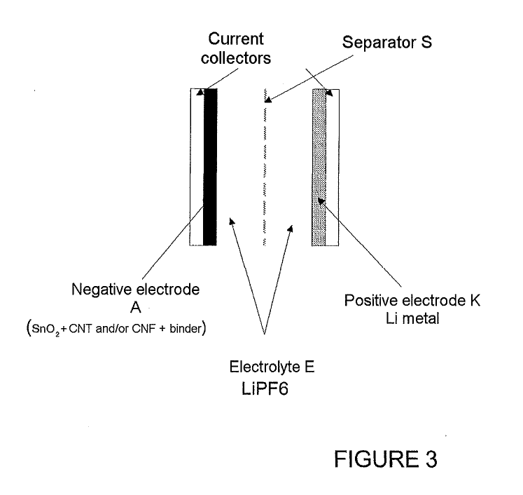

### EXAMPLE 2—FIG. 3—

The electrochemical performances were characterized in lithium batteries, that is to say that the positive electrode K consists of metallic lithium and the electrolyte E is a lithium salt in an organic solvent having an EC/DMC (ethylene carbonate/dimethyl carbonate) composition of 1/1 by volume, with an LiPF₆ concentration equal to 1M.

The negative electrode A consists of a mixture of 80% by weight of active material (CNT/SnO₂) and of 20% by weight of PVDF (polyvinylidene difluoride), which is a binder that makes it possible to ensure a good mechanical strength of the electrode. These various constituents are introduced into N-methylpyrrolidone in order to obtain a very homogeneous mixture. This mixture is then coated onto a glass plate by a “doctor BLADE” coating plate. The coating is carried out to a thickness of 150 μm.

Electrodes having a diameter of 11 mm are then cut in this film and dried for several hours (6 to 8 h) at 80° C. under vacuum.

Once in a cell (button cell), the negative electrode A is successively covered by a separator S (polypropylene saturated with electrolyte) and by the positive electrode K which is a pellet of metallic lithium. The electrolyte used is a lithium salt (LiPF₆, 1M) dissolved in the mixture of EC/DMC (ethylene carbonate/dimethyl carbonate) organic solvents in volume proportions of 1/1.

Various individual cells thus formed are assembled in a glovebox under a controlled atmosphere in order to form a battery.

The various electrochemical tests are carried out on VMP3 (Biologic SAS). The electrochemical behavior of the CNT/SnO₂ composites was studied in galvanostatic mode under a C/10 constant regime in the potential window [0.02-1.2] V (vs. Li⁺/Li).

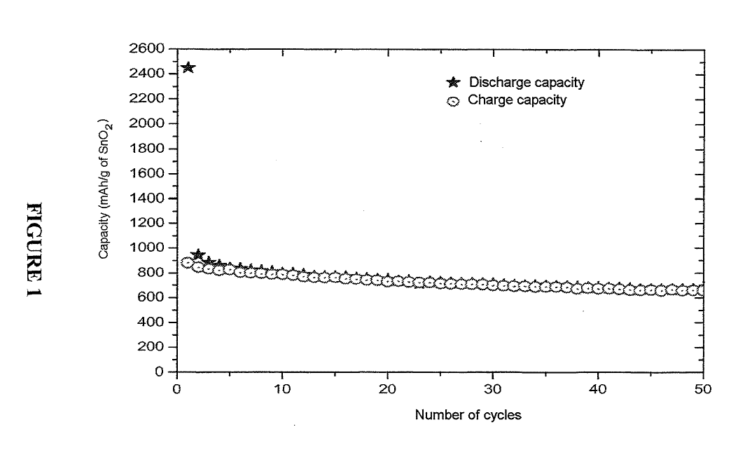

FIG. 1 represents the charge-discharge electrochemical performances of the carbon nanotube/SnO₂ composite used as negative electrode (anode) for Li-ion batteries.

This negative electrode consists of the composite synthesized by the process that has been described. The reversible capacity drops at the end of the first cycle but is maintained at around 700 mAh/g for more than 30 cycles. After 60 cycles, the capacity of the composite remains above 600 mAh/g.

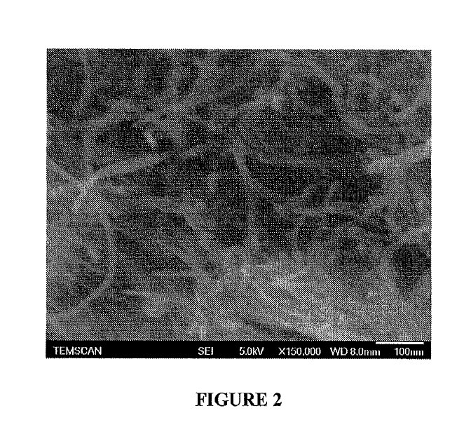

FIG. 2 is a view under an electron microscope of the CNT/SnO₂ composite. In this figure, it is possible to see the homogeneous distribution of the tin nanoparticles on the walls of the carbon nanotubes and a virtual absence of unsupported particles.

### EXAMPLE 3

This example repeats the test conditions from Example 2 but replacing, in the synthesis, half of the carbon nanotubes, i.e. 0.5 g, with 0.5 g of carbon nanofibers (by way of example, these are carbon nanofibers sold by Showa Denko, the diameter of which is 150 nm).

Before preparation of the composite, these nanofibers were treated in the presence of sodium hypochlorite.

A negative electrode A is then manufactured with this new composite. The reversible capacity drops at the end of the first cycle but is maintained at around 870 mAh/g for more than 30 cycles. After 60 cycles, the capacity of the composite remains above 750 mAh/g.

The nanofibers are capable of ensuring electrical connections over long distances and the carbon nanotubes act more at the local level.

Indeed, the nanotubes appear to play the role of “elastomeric” material for accommodating the volume variations, and also of short-distance electrical connectors between particles whilst the nanofibers appear to play the role of long-distance connectors.

In any case, the nanotubes used are purified so that the ash content is less than 2.5% by weight loss at 900° C. in air, since after synthesis, the nanotubes contain catalytic residues which may reach up to 10% by weight.

Embodiments of the invention presented here makes it possible for a tin oxide SnO₂ to obtain a reversible capacity of the order of 850 mAh/g after 50 cycles without detrimental volume expansion. The composite obtained by the process (SnO₂ with a fibrillar carbon-based material) also gives the following results:

an increase in the specific surface area owing to the nanoscale size of the SnO₂ particles, enabling a reduction in the diffusion length of the lithium during the deintercalation/intercalation of the lithium; and

an increase in the electronic conductivity owing to the addition of the fibrillar carbon-based material.

1. A process for manufacturing a composite comprising particles of tin oxide and a fibrillar carbon-based material, the process comprising a synthesis by precipitation/nucleation in a water-alcohol medium of particles of tin hydroxide resulting from a tin salt in the presence of the fibrillar carbon-based material and an acid,
wherein the fibrillar carbon-based material consists of carbon nanotubes or carbon nanofibers or a mixture of carbon nanotubes and carbon nanofibers, and
wherein the synthesis comprises a dissolving/contacting phase carried out at ambient temperature and at atmospheric pressure, then a nucleation/crystallization phase carried out at a temperature above ambient temperature and a heat treatment phase.

2. The process for manufacturing a composite as claimed in claim 1, wherein, in the dissolving/contacting phase, a) the tin salt is dissolved in a water, alcohol and acid mixture and stirred, then water is added while maintaining the stirring, b) the fibrillar carbon-based material is added and the mixture is stirred; for wherein steps a) and b) are carried out in this order or in the reverse order.

3. The process for manufacturing a composite as claimed in claim 1, wherein the nucleation/crystallization phase comprises an evaporation to dryness.

4. The process for manufacturing a composite as claimed in claim 3, wherein the evaporation to dryness is carried out in an oven at a temperature between 25 and 70° C.

5. The process for manufacturing a composite as claimed in claim 1, wherein the heat treatment phase is carried out under nitrogen or in air for about 10 minutes at a temperature between 300° C. and 500° C.

6. The process for manufacturing a composite as claimed in claim 1, wherein the fibrillar material is added in the form of a prior predispersion.

7. The process for manufacturing a composite as claimed in claim 1, wherein, the fibrillar material is added in the form of powder.

8. (canceled)

9. (canceled)

10. The process for manufacturing a composite as claimed in claim 1, wherein the carbon nanotubes are multi-walled CNTs having an external diameter ranging from 3 to 50 nm.

11. The process for manufacturing a composite as claimed in claim 1, wherein the fibrillar carbon-based material is pretreated so as to be purified by oxidation in order to have polar surface functional groups of OH and/or COON type.

12. The process for manufacturing a composite as claimed in claim 11, wherein the polar surface functional groups are obtained by treating the fibrillar carbon-based material in an acid such as HNO₃ or H₂SO₄.

13. The process for manufacturing a composite as claimed in claim 12, wherein the treatment with an acid is followed by a surface oxidation operation using sodium hypochlorite (NaOCl) or aqueous hydrogen peroxide solution (H₂O₂) or ozone (O₃) when the acid chosen for purifying is not sufficiently oxidizing.

14. A composite obtained by the process as claimed in claim 1, wherein it the composite consists of a homogeneous distribution of tin particles on the walls of the fibrillar carbon-based material with a virtual absence of tin particles that are not supported by said material, and
wherein the fibrillar carbon-based material consists of multi-walled CNTs having an external diameter ranging from 3 to 50 nm or of a mixture of carbon nanotubes and carbon nanofibers.

15. The composite as claimed in claim 14, wherein the composite consists of 20 to 35% by weight of fibrillar carbon-based material and from 65 to 80% by weight of tin oxide particles.

16. The composite as claimed in claim 14, wherein, in the case where the fibrillar carbon-based material is a mixture of carbon nanotubes and carbon nanofibers, the fibrillar carbon-based material consisting of the two constituents.

17. The composite as claimed in claim 14, wherein the composite consists of carbon nanotubes and tin oxide particles, and
wherein the composite has, in galvanostatic cycling, a capacity of greater than 600 mAh/g after 60 cycles.

18. The composite as claimed in claim 16, wherein the composite consists of carbon nanotubes, carbon nanofibers and tin oxide particles, and
wherein the composite has, in galvanostatic cycling, a capacity of greater than 750 mAh/g after 60 cycles.

19. An electrode comprising a composite as claimed in claim 14.

20. The electrode as claimed in claim 19, wherein the electrode is a lithium-ion battery negative electrode, and the electrode comprises a mixture of at least 80% by weight of active material and at most 20% by weight of binder.

21. The negative electrode as claimed in claim 20, wherein the binder consists of polyvinylidene difluoride (PVDF), of polyvinylpyrrolidone (PVP) or of carboxymethyl cellulose (CMC).

22. A lithium-ion battery comprising a negative electrode as claimed in claim 19.
